(19) United States
(12) Patent Application Publication
(10) Pub. No.: US 2023/0373226 A1
(43) Pub. Date: Nov. 23, 2023

(54) THERMAL HEAD AND THERMAL PRINTER

(71) Applicant: KYOCERA Corporation, Kyoto (JP)

(72) Inventors: Yasuhiro KYUNAI, Okaya-shi, Nagano (JP); Seiichirou HIRAHARA, Kirishima-shi, Kagoshima (JP); Tomoki YAMASHITA, Kirishima-shi, Kagoshima (JP); Tatsuya KITAHARA, Kirishima-shi, Kagoshima (JP)

(21) Appl. No.: 18/028,214

(22) PCT Filed: Sep. 28, 2021
(86) PCT No.: PCT/JP2021/035716

§ 371 Date: Mar. 24, 2023

(30) Foreign Application Priority Data
Sep. 30, 2020 (JP) 2020-166488
Sep. 28, 2021 (WO) PCT/JP2021/035716

(51) Int. Cl. B41J 2/345; B41J 2/335

(52) U.S. Cl. CPC B41J 2/345; B41J 2/3353

(57) ABSTRACT

A thermal head includes a substrate, electrodes, and a resistor layer. The electrodes are located on the substrate and extend along a first direction of the substrate in a plan view. The resistor layer is located on the substrate and on the electrode. The electrodes include a first electrode and a second electrode arranged at a predetermined interval in a second direction intersecting the first direction. In at least one of the first electrode and the second electrode, a central portion in the second direction protrudes out farther than an end portion in the second direction on the upper surface located below the resistor layer.

### CROSS-REFERENCE TO RELATED APPLICATIONS

This application is national stage application of International Application No. PCT/JP2021/035716, filed on Sep. 28, 2021, which claims the benefit of priority from Japanese Patent Application No. 2020-166488, filed on Sep. 30, 2020.

### TECHNICAL FIELD

Embodiments of this disclosure relate to a thermal head and a thermal printer.

### BACKGROUND OF INVENTION

Various kinds of thermal heads for printing devices such as facsimile machines and video printers have been proposed in the related art.

### CITATION LIST

### Patent Literature

Patent Document 1: JP 54-99443 A
Patent Document 2: JP 2019-119149 A

### SUMMARY

A thermal head according to an aspect of an embodiment includes a substrate, an electrode, and a resistor layer. The electrode is located on the substrate and extends along a first direction of the substrate. The resistor layer is located on the substrate and on the electrode. The electrode includes a first electrode and a second electrode arranged at a predetermined interval in a second direction intersecting the first direction. In at least one of the first electrode and the second electrode, a central portion protrudes out farther in the second direction than an end portion in the second direction on an upper surface located below the resistor layer.

In an aspect of an embodiment, a thermal printer includes the thermal head described above, a transport mechanism, and a platen roller. The transport mechanism transports a recording medium on a heat generating part located on the substrate. The platen roller presses the recording medium on the heat generating part.

### BRIEF DESCRIPTION OF THE DRAWINGS

FIG. 1 is a perspective view schematically illustrating a thermal head according to an embodiment.

FIG. 2 is a cross-sectional view schematically illustrating the thermal head illustrated in FIG. 1.

FIG. 3 is a plan view schematically illustrating a head base illustrated in FIG. 1.

FIG. 4 is a cross-sectional view taken along line IV-IV in FIG. 3.

FIG. 5 is a cross-sectional view illustrating the main portion of a thermal head according to a reference embodiment.

FIG. 6 is a cross-sectional view illustrating the main portion of a thermal head according to first and second variations of the embodiment.

FIG. 7A is an enlarged cross-sectional view of a portion P1 illustrated in FIG. 6.

FIG. 7B is an enlarged cross-sectional view of a portion P2 illustrated in FIG. 6.

FIG. 8 is a cross-sectional view illustrating the main portion of a thermal head according to a third variation of the embodiment.

FIG. 9 is a cross-sectional view illustrating the main portion of a thermal head according to a fourth variation of the embodiment.

FIG. 10 is a cross-sectional view illustrating the main portion of a thermal head according to a fifth variation of the embodiment.

FIG. 11 is a cross-sectional view illustrating the main portion of a thermal head according to a sixth variation of the embodiment.

FIG. 12 is a schematic view of a thermal printer according to an embodiment.

FIG. 13A is a perspective view of a simulation model.

FIG. 13B is a plan view of the simulation model illustrated in 13A.

FIG. 14A is a side view of the simulation model illustrated in FIG. 13A as viewed from the long side.

FIG. 14B is a side view of a simulation model of the thermal head according to the embodiment as viewed from a short side.

FIG. 14C is a side view of a simulation model of a thermal head according to a reference embodiment as viewed from a short side.

FIG. 15 is a table summarizing the physical property values used in the simulation.

FIG. 16 is a graph showing simulation results.

FIG. 17A is a diagram illustrating simulation results of the thermal head according to the embodiment.

FIG. 17B is a diagram illustrating simulation results of the thermal head according to the reference embodiment.

### DESCRIPTION OF EMBODIMENTS

Embodiments of a thermal head and a thermal printer disclosed in the present application will be described below with reference to the accompanying drawings. Note that this invention is not limited to each of the embodiments that will be described below.

The structure of a known thermal head has room for improvement, for example, in terms of improving print image quality. The present disclosure has been made in light of the foregoing, and provides a thermal head and a thermal printer capable of improving the print image quality.

### EMBODIMENTS

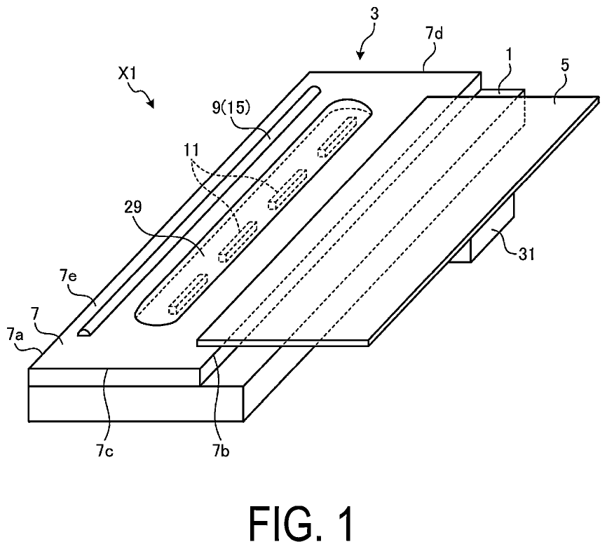

FIG. 1 is a perspective view schematically illustrating a thermal head according to an embodiment. In the embodiment, a thermal head X1 includes a heat dissipation body 1, a head base 3, and a flexible printed circuit board (FPC) 5 as illustrated in FIG. 1. The head base 3 is located on the heat dissipation body 1. The FPC 5 is electrically connected to the head base 3. The head base 3 includes a substrate 7, a heat generating part 9, a plurality of drive ICs 11, and a covering member 29.

The heat dissipation body 1 has a plate shape. The heat dissipation body 1 has a rectangular shape in plan view. The heat dissipation body 1 has a heat dissipating function. Specifically, the heat dissipation body 1 emits, to the outside of a thermal head X1, heat that does not contribute to printing out of the heat generated in the heat generating part 9 of the head base 3. The head base 3 is bonded to an upper surface of the heat dissipation body 1 using a double-sided tape, an adhesive, or the like (not illustrated). The heat dissipation body 1 is made of, for example, a metal material such as copper, iron, or aluminum.

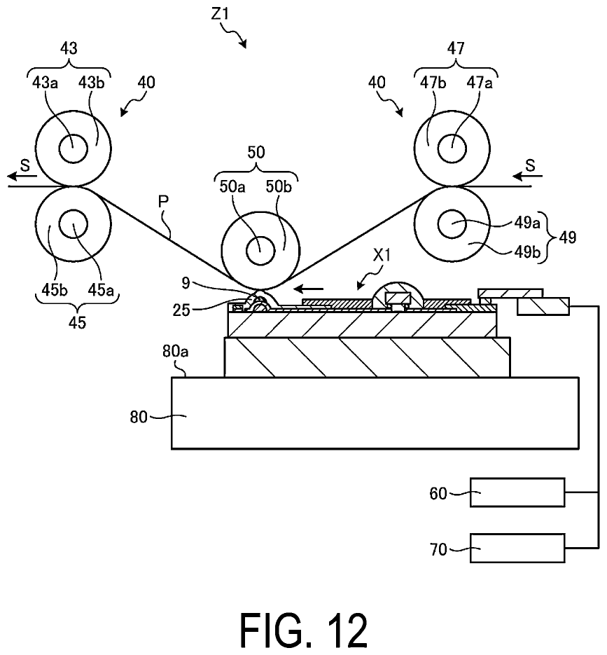

The head base 3 has a plate shape. The head base 3 has a rectangular shape in plan view. The head base 3 includes each member constituting the thermal head X1 located on the substrate 7. The head base 3 performs printing on a recording medium P (see FIG. 12) in accordance with an electrical signal provided from outside.

The drive ICs 11 are located on the substrate 7. The plurality of drive ICs 11 are located along the main scanning direction. The drive ICs 11 are electronic components having a function of controlling a conductive state of the heat generating part 9. As an example, a switching member having a plurality of switching elements therein may be used as the drive ICs 11.

The drive ICs 11 are covered by a covering member 29 made of resin such as epoxy resin or silicone resin. The covering member 29 is located across the plurality of drive ICs 11. The covering member 29 is an example of a sealing material.

The FPC 5 has, for example, a pair of a first end and a second end in the short-side direction. The first end of the FPC 5 is electrically connected to the head base 3. The second end of the FPC 5 is electrically connected to a connector 31.

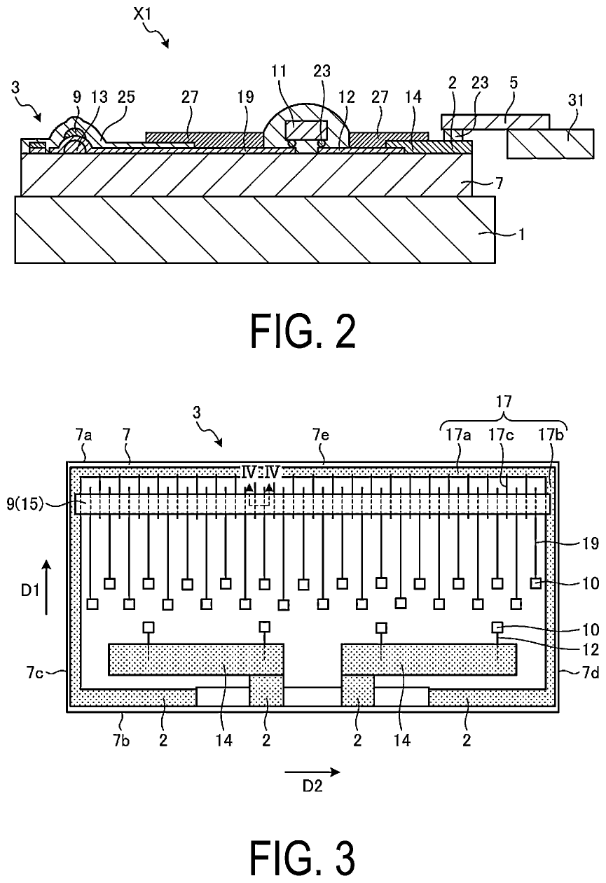

The FPC 5 is electrically connected to the head base 3 using an electrically conductive bonding material 23 (see FIG. 2). As an example, an anisotropic conductive film (ACF) in which conductive particles are mixed in a solder material or an electrically insulating resin may be used as the conductive bonding material 23.

Hereinafter, each of the members constituting the head base 3 will be described using FIGS. 1 to 3. FIG. 2 is a cross-sectional view schematically illustrating the thermal head illustrated in FIG. 1. FIG. 3 is a plan view schematically illustrating the head base illustrated in FIG. 1.

The head base 3 further includes the substrate 7, common electrodes 17, individual electrodes 19, third electrodes 12, fourth electrodes 14, terminals 2, a resistor layer 15, a protective layer 25, and a covering layer 27. Note that, in FIG. 1, the protective layer 25 and the covering layer 27 are omitted. FIG. 3 illustrates the wiring of the head base 3 in a simplified manner Note that in FIG. 3, the drive ICs 11, the protective layer 25, and the covering layer 27 are omitted. In FIG. 3, the configuration of the fourth electrodes 14 is simplified.

The substrate 7 has a rectangular shape in plan view. A main surface (upper surface) 7e of the substrate 7 includes a first long side 7a that is one long side, a second long side 7b that is the other long side, a first short side 7c, and a second short side 7d. The substrate 7 is made of an electrically insulating material such as an alumina ceramic or a semiconductor material such as monocrystalline silicon.

The substrate 7 may include a heat storage layer 13. The heat storage layer 13 protrudes from the main surface 7e in the thickness direction of the substrate 7, and extends in a strip shape in a second direction D2 (the main scanning direction). The heat storage layer 13 has a function of favorably pressing a recording medium, on which printing is performed, against the protective layer 25 located on the heat generating part 9.

Note that the heat storage layer 13 may include an underlying portion. In this case, the underlying portion is a portion located in the entire area of the heat storage layer 13 on the main surface 7e of the substrate 7.

The heat storage layer 13 contains, for example, a glass component. The heat storage layer 13 temporarily stores some of the heat generated in the heat generating part 9. As a result, the heat storage layer 13 can shorten the time required to raise the temperature of the heat generating part 9. That is, the heat storage layer 13 has a function of enhancing the thermal response characteristics of the thermal head X1.

The heat storage layer 13 is made by, for example, applying a predetermined glass paste obtained by mixing glass powder with an appropriate organic solvent onto the main surface 7e of the substrate 7 using a known screen printing method or the like, and firing the main surface. Note that the substrate 7 may have only an underlying portion as the heat storage layer 13.

The common electrodes 17 are located on the main surface 7e of the substrate 7 as illustrated in FIG. 3. The common electrodes 17 are made of a material having conductivity. For example, any one type of metal of aluminum, gold, silver, and copper, or an alloy thereof may be used as the common electrodes 17.

As illustrated in FIG. 3, the common electrodes 17 include a first common electrode 17a, a plurality of second common electrodes 17b, a plurality of third common electrodes 17c, and a plurality of terminals 2. The common electrodes 17 are electrically connected commonly to a plurality of elements of the heat generating part 9.

The first common electrode 17a is located between the first long side 7a of the substrate 7 and the heat generating part 9. The first common electrode 17a extends in the main scanning direction. The plurality of second common electrodes 17b extend in the sub-scanning direction. One of the plurality of (here, two) second common electrodes 17b is located on the first short side 7c side of the substrate 7, and the other one is located on the second short side 7d side. The second common electrodes 17b are connected to the terminals 2 and the first common electrode 17a. The third common electrodes 17c extend in a comb shape from the first common electrode 17a toward each element of the heat generating part 9, and one part thereof is inserted into the opposite side of the heat generating part 9. The third common electrodes 17c are located at intervals in a second direction D2 (the main scanning direction). The third common electrodes 17c are an example of the first electrode.

The individual electrodes 19 are located on the main surface 7e of the substrate 7. The individual electrodes 19 contain a metal component and thus have electrical conductivity. The individual electrodes 19 are made of, for example, a metal such as aluminum, nickel, gold, silver, platinum, palladium, copper, or an alloy of these metals. The plurality of individual electrodes 19 are located along the main scanning direction. Each individual electrode 19 is located between two corresponding adjacent third common electrodes 17c. Therefore, in the thermal head X1, the third common electrodes 17c and the individual electrodes 19 are alternately located in the main scanning direction. Each individual electrode 19 is connected to an electrode pad 10 at a portion close to the second long side 7b of the substrate 7. The individual electrode 19 is an example of a second electrode.

The third electrodes 12 are connected to corresponding electrode pads 10. The third electrodes 12 extend in the sub-scanning direction. The drive ICs 11 are mounted on the electrode pads 10 as described above.

The fourth electrodes 14 extend in the main scanning direction. The fourth electrodes 14 are located across the plurality of third electrodes 12. The fourth electrodes 14 are connected to the outside by the terminals 2.

The terminals 2 are located on the second long side 7b side of the substrate 7. The terminals 2 are connected to the FPC 5 via the electrically conductive bonding material 23 (see FIG. 2). In this way, the head base 3 is electrically connected to the outside.

In the individual electrodes 19, the third common electrodes 17c, and the third electrodes 12 described above, for example, a conductor paste containing a metal component and a glass component in an organic solvent can be used as an electrode material. The individual electrodes 19, the third common electrodes 17c, and the third electrodes 12 can form each constituting material layer on the substrate 7 by, for example, a screen printing method, a flexographic printing method, a gravure printing method, a gravure offset printing method, or the like. The individual electrodes 19, the third common electrodes 17c, and the third electrodes 12 may be produced by sequentially layering by a well-known thin-film forming technique such as a sputtering method, and then processing the laminate into a predetermined pattern using well-known photoetching or the like.

The first common electrode 17a, the second common electrodes 17b, the fourth electrodes 14, and the terminals 2 can produce each constituting material layer on the substrate 7 by, for example, a screen printing method. The thickness of each of the first common electrode 17a, the second common electrodes 17b, the fourth electrodes 14, and the terminals 2 is, for example, approximately from 5 to 20 μm. By forming the thick electrode in this manner, the wiring resistance of the head base 3 can be reduced. Note that the portion of the thick electrode is illustrated by dots in FIG. 3, and this also applies to the following drawings.

The resistor layer 15 is located across the third common electrodes 17c and the individual electrodes 19 in a state spaced apart from the first long side 7a of the substrate 7. A portion of the resistor layer 15 located between the third common electrodes 17c and the individual electrodes 19 functions as each element of the heat generating part 9. Each element of the heat generating part 9 is described in a simplified manner in FIG. 3, but may be located at a density of, for example, greater than or equal to 100 dots per inch (dpi). Each element of the heat generating part 9 may be located at a density of 200 to 2400 dpi.

The thickness of the resistor layer 15 is, for example, from about 3 to 6 μm. The sheet resistance of the resistor layer 15 is, for example, from about 500 to 8000Ω/□. The coefficient of thermal expansion of the resistor layer 15 is, for example, from about 5 to 10 ppm/° C. The thermal conductivity of the resistor layer 15 is, for example, from about 0.5 to 2 W/(m K).

The resistor layer 15 may be formed, for example, by positioning a material paste containing a conductive component and a glass component on the substrate 7 on which various electrodes are patterned in a long band shape in the main scanning direction by a screen printing method, a dispensing device, or the like. The conductive component may contain, for example, ruthenium oxide. The glass component may contain, for example, lead borosilicate glass.

The protective layer 25 is located on the heat storage layer 13 formed on the main surface 7e (see FIG. 1) of the substrate 7. The protective layer 25 covers the heat generating part 9. The protective layer 25 is located extending from the first long side 7a of the substrate 7 but separated from the electrode pad 10 and extending in the main scanning direction of the substrate 7.

The protective layer 25 has an insulating property. As a result, the protective layer 25 protects the covered region from corrosion due to adhesion of moisture or the like contained in the atmosphere or wear due to contact with a recording medium on which printing is performed. The protective layer 25 can be made of, for example, glass. The protective layer can be made, for example, using a thick film forming technique such as printing. The protective layer 25 may include, for example, lead borosilicate glass. The protective layer 25 may further contain, for example, alumina and/or zirconia.

The protective layer 25 may be produced using SiN, SiON, SiO₂, SiC, C—SiC, TiN, TiAlN, TiC, TiCN, TiSiN, CrN, diamond-like carbon (DLC), or the like. The protective layer such as that described above can be formed using a thin film forming technique such as a sputtering method.

The protective layer 25 may have, for example, a surface roughness Ra of less than or equal to 0.3 μm.

The covering layer 27 is located on the substrate 7 so as to partially cover the common electrodes 17, the individual electrodes 19, the third electrodes 12, and the fourth electrodes 14. The covering layer 27 protects the covered region from oxidation due to contact with the atmosphere or from corrosion due to deposition of moisture and the like contained in the atmosphere. The covering layer 27 can be made of a resin material such as an epoxy resin, a polyimide resin, or a silicone resin.

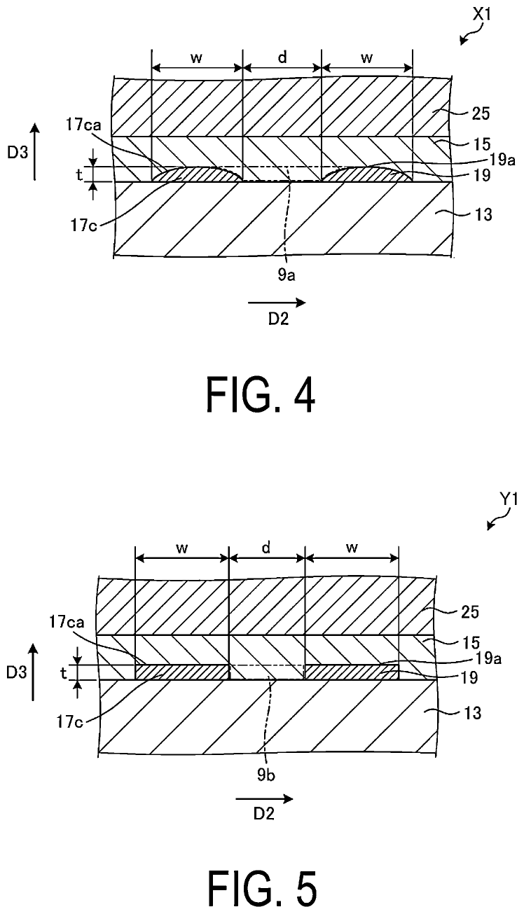

The main portion of the thermal head X1 according to an embodiment will be described in detail using FIG. 4. FIG. 4 is a cross-sectional view taken along line IV-IV in FIG. 3.

As illustrated in FIG. 4, the thermal head X1 according to the embodiment includes a heat storage layer 13, a third common electrodes 17c, individual electrodes 19, a resistor layer 15, and a protective layer 25.

The third common electrodes 17c and the individual electrodes 19 are located on the heat storage layer 13. The third common electrodes 17c and the individual electrodes 19 are spaced apart from each other by a distance d.

The resistor layer 15 is located on the third common electrodes 17c and the individual electrodes 19, and on the heat storage layer 13 without the third common electrodes 17c and the individual electrodes 19. Thus, the third common electrodes 17c and the individual electrodes 19 are sandwiched between the heat storage layer 13 and the resistor layer 15. The protective layer 25 is located so as to cover the resistor layer 15.

Here, cross-sectional shapes of the third common electrodes 17c and the individual electrodes 19 will be described. Each of the third common electrodes 17c has, on an upper surface 17ca located below the resistor layer 15, the central portion in the second direction D2 protruding out toward the third direction D3 side farther than the end portion in the second direction D2. The third direction D3 is a direction intersecting the first direction D1 (see FIG. 3) and the second direction D2. Similarly, each of the individual electrodes 19 has, on the upper surface 19a located below the resistor layer 15, the central portion in the second direction D2 protruding out toward the third direction D3 side farther than the end portion in the second direction D2.

The widths w of the individual electrodes 19 and the third common electrodes 17c are, for example, from about 10 to 50 μm. The widths w of the individual electrodes 19 and the third common electrodes 17c may be, for example, from about 20 to 30 μm. The thicknesses t of the individual electrodes 19 and the third common electrodes 17c are, for example, from about 0.5 to 5 μm. The thicknesses t of the individual electrodes 19 and the third common electrodes 17c may be from about 1 to 2 μm. The widths w of the individual electrodes 19 and the third common electrodes 17c may be the same or different. The thicknesses t of the individual electrodes 19 and the third common electrodes 17c may be the same or different.

As described above, in the individual electrodes 19 and the third common electrodes 17c, the central portions of the upper surface 17ca and the upper surface 19a protrude toward the third direction D3 side. As a result, in the thermal head X1 according to the embodiment, the print image quality is improved as compared with the case where the upper surfaces 17ca and 19a of the individual electrodes 19 and the third common electrodes 17c are flat along the first direction D1 (see FIG. 3) and the second direction D2. This point will be further described using FIGS. 4 and 5.

FIG. 5 is a cross-sectional view illustrating the main portion of a thermal head according to a reference embodiment. As illustrated in FIG. 5, a thermal head Y1 according to the reference embodiment has the same configuration as that of the thermal head X1 illustrated in FIG. 4 except that the third common electrode 17c and the individual electrode 19 have rectangular cross sections.

The thermal head X1 illustrated in FIG. 4 and the thermal head Y1 illustrated in FIG. generate heat when a predetermined voltage is applied between the third common electrode 17c and the individual electrode 19. Specifically, in the thermal head X1 illustrated in FIG. 4, a portion 9a of the resistor layer 15 sandwiched between the third common electrode 17c and the individual electrode 19 and having a substantially trapezoidal cross section serves as a main heat generating site.

On the other hand, in the thermal head Y1 illustrated in FIG. 5, a portion 9b of the resistor layer 15 sandwiched between the third common electrode 17c and the individual electrode 19 and having a substantially trapezoidal cross section serves as a main heat generating site.

In the thermal heads X1 and Y1, when the widths w and the thicknesses t of the third common electrode 17c and the individual electrode 19, and the interval d between the third common electrode 17c and the individual electrode 19 are equalized, the portion 9a has a larger cross-sectional area and volume than the portion 9b. At this time, it is assumed that the resistance values between the third common electrode 17c and the individual electrode 19 are the same in FIG. 4 between the thermal heads X1 and Y1. In this case, when pulse voltages under the same conditions are applied to the thermal heads X1 and Y1, heat is more easily transferred to the resistor layer 15 away from the portion 9a in the thermal head X1 having a larger heat generating site than in the thermal head Y1. Therefore, the temperature of the resistor layer 15 located on the central portions in the second direction D2 of the upper surface 17ca and the upper surface 19a defining the adjacent heat generating parts 9 (see FIGS. 1 to 3) can be appropriately raised. As a result, the temperature difference between sites on the upper surface of the resistor layer 15 is reduced. This improves the connection of dots in the printed matter printed by the thermal head X1, thereby improving the print image quality.

As described above, the third common electrodes 17c and the individual electrodes 19 in the thermal head X1 can form the material layer constituting each of the electrodes on the substrate 7 by, for example, a screen printing method, a flexographic printing method, a gravure printing method, a gravure offset printing method, or the like. For example, a paste produced by an intaglio plate having a desired groove shape is transferred to a bracket which is an intermediate supporting body. Next, the paste is transferred again onto the heat storage layer 13 while appropriately adjusting the holding time and the pressing strength. As a result, a material layer having a desired shape can be located on the substrate 7. However, the method of producing the third common electrodes 17c and the individual electrodes 19 is not limited to the above, and the third common electrodes 17c and the individual electrodes 19 may be positioned by any method.

Variation

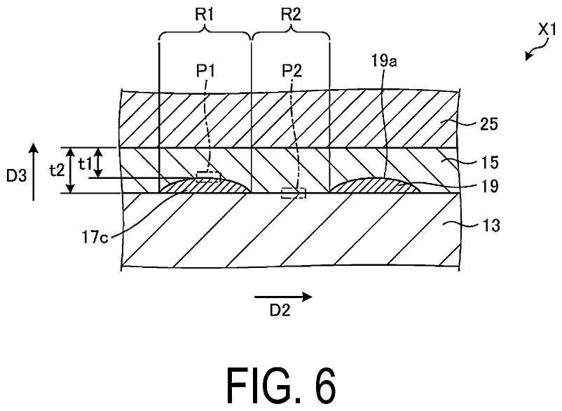

The thermal head X1 according to first to sixth variations of the embodiment will be described. FIG. 6 is a cross-sectional view illustrating the main portion of the thermal head according to the first and second variations of the embodiment.

As illustrated in FIG. 6, in the thermal head X1 according to the first variation, the thickness t1 of the resistor layer 15 located on the central portion in the width direction (second direction D2) of the third common electrode 17c (and the individual electrode 19) is smaller than the thickness t2 of the resistor layer 15 located on the end portion in the second direction D2. By making the thickness t1 smaller than the thickness t2, the thermal conduction distance to the surface of the resistor layer 15 located in the region R1 where the heat generation amount is smaller than that of the heat generating part 9 (see FIGS. 1 to 3) is smaller than the thermal conduction distance to the surface of the resistor layer 15 located in the region R2. As a result, the temperature difference between sites on the upper surface of the resistor layer 15 is reduced. This improves the connection of dots in the printed matter printed by the thermal head X1, thereby improving the print image quality.

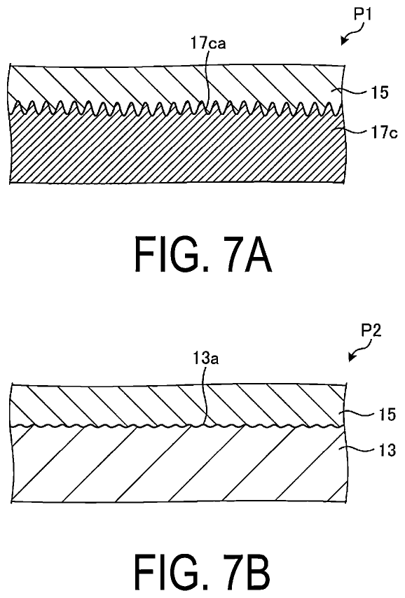

In the thermal head X1 according to the second variation, the uneven shape of the interface is different between a portion P1 and a portion P2 illustrated in FIG. 6. FIG. 7A is an enlarged cross-sectional view of the portion P1 illustrated in FIG. 6. FIG. 7B is an enlarged cross-sectional view of the portion P2 illustrated in FIG. 6.

As illustrated in FIGS. 7A and 7B, the unevenness (see FIG. 7A) of the interface between the upper surface 17ca of the third common electrode 17c and the resistor layer 15 may be larger than the unevenness (see FIG. 7B) of the interface 13a between the resistor layer 15 and the heat storage layer 13. Here, regarding the unevenness of the interface, in the photograph of the cross section, the height difference between the highest point and the lowest point (the height difference between the most protruding portion and the most recessed portion) in the region having a length of 10 μm along the interface at an arbitrary place is measured, and such a height difference may be defined as the size of the unevenness of the interface. The size of the unevenness can be determined by visual observation or the like based on, for example, a scanning electron microscope (SEM) image. Although not illustrated, the unevenness of the interface between the upper surface 19a of the individual electrode 19 and the resistor layer 15 can be made substantially the same as the unevenness of the interface between the upper surface 17ca and the resistor layer 15. That is, the unevenness of the interface between the upper surface 19a and the resistor layer 15 may be larger than the unevenness of the interface between the resistor layer 15 and the heat storage layer 13.

When the unevenness of the interface between the resistor layer 15 and the heat storage layer 13 is reduced, for example, the variation in the current path at the interface between the resistor layer 15 and the heat storage layer 13 located in the region R2 is reduced. When the unevenness of the interface between the upper surface 17ca and the resistor layer 15 is increased, for example, interface resistance between the upper surface 17ca located in the region R1 and the resistor layer 15 is reduced, and variation in interface resistance can be reduced. As a result, the variation in the resistance value between the electrodes adjacent in the second direction D2 is reduced, and the density unevenness between the dots in the printed matter printed by the thermal head X1 can be reduced, so that the print image quality is improved.

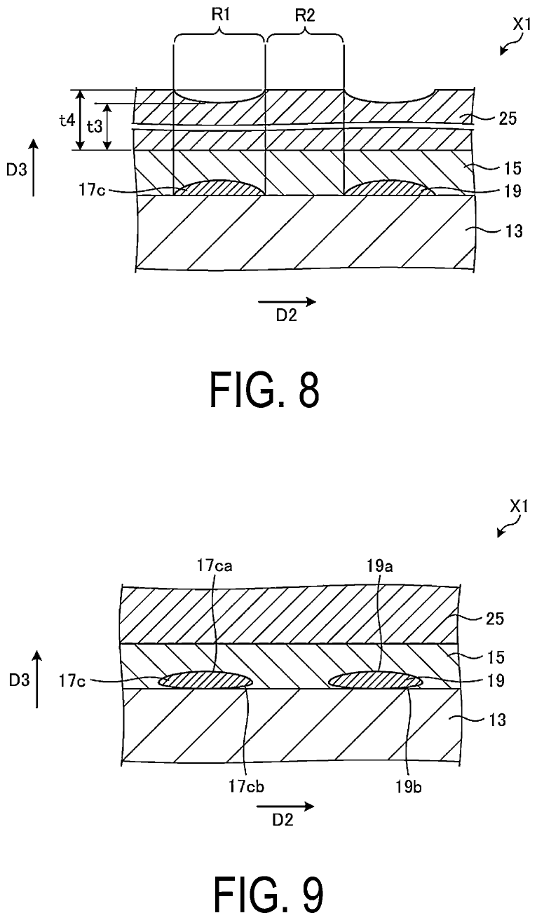

A thermal head X1 according to a third variation will be described with reference to FIG. 8. FIG. 8 is a cross-sectional view illustrating the main portion of the thermal head according to the third variation of the embodiment.

As illustrated in FIG. 8, the thickness t3 of the protective layer 25 located on the third common electrode 17c (and the individual electrode 19) may be smaller than the thickness t4 of the protective layer 25 located on the resistor layer 15 located between the third common electrode 17c and the individual electrode 19.

By reducing the thickness of the protective layer 25 located in the region R1 where the heat generation amount is smaller than that of the heat generating part 9 (see FIGS. 1 to 3), the thermal conduction distance to the surface of the protective layer 25 becomes smaller than the thermal conduction distance to the surface of the protective layer 25 located in the region R2. As a result, the temperature difference between the sites on the upper surface of the protective layer 25 is reduced. This improves the connection of dots in the printed matter printed by the thermal head X1, thereby improving the print image quality.

The protective layer 25 illustrated in FIG. 8 can be produced by the following procedure. That is, for example, a pattern having a portion where the material layer of the protective layer 25 is not located is formed on the resistor layer 15 located on the third common electrode 17c (and the individual electrode 19) by, for example, screen printing or the like. Thereafter, the protective layer 25 illustrated in FIG. 8 can be located on the resistor layer 15 by softening and flowing of the material layer by firing. The method for producing the protective layer 25 is not limited, and the protective layer 25 may be positioned by any method.

A thermal head X1 according to a fourth variation will be described with reference to FIG. 9. FIG. 9 is a cross-sectional view illustrating the main portion of the thermal head according to the fourth variation of the embodiment.

As illustrated in FIG. 9, the third common electrode 17c and the individual electrode 19 have the central portion in the second direction D2 protruding out farther than the end portion in the second direction D2 at the upper surfaces 17ca and 19a. The third common electrode 17c and the individual electrode 19 may have the central portion in the second direction D2 protruding out toward the negative direction side (the heat storage layer 13 side) in the third direction D3 farther than the end portion in the second direction D2 at the lower surfaces 17cb and 19b located on the heat storage layer 13.

In the third common electrode 17c, the protrusion amount of the central portion with respect to the end portion in the second direction D2 is smaller in the lower surface 17cb than in the upper surface 17ca. Similarly, in the individual electrode 19, the protrusion amount of the central portion with respect to the end portion in the second direction D2 is smaller in the lower surface 19b than in the upper surface 19a.

In the thermal head X1 illustrated in FIG. 9, when a predetermined voltage is applied between the third common electrode 17c and the individual electrode 19, the portion 9c of the resistor layer 15 sandwiched between the third common electrode 17c and the individual electrode 19 becomes a main heat generating site. Since the protrusion amount on the lower surface 17cb, 19b side is smaller than the protrusion amount on the upper surface 17ca, 19a side, the heat generation amount on the heat storage layer 13 side of the portion 9c located on the lower side opposite to the upper surface of the resistor layer 15 can be reduced. The temperature on the upper surface side of the resistor layer 15 can be appropriately raised. This improves the connection of dots in the printed matter printed by the thermal head X1, thereby improving the print image quality.

Here, the ratio (lower surface side protrusion amount/upper surface side protrusion amount) of the protrusion amount (lower surface side protrusion amount) on the lower surface 17cb, 19b side with respect to the protrusion amount (upper surface side protrusion amount) on the upper surface 17ca, 19a side can be, for example, smaller than or equal to 0.75. The lower surface side protrusion amount may be 0. However, the value of the lower surface side protrusion amount/the upper surface side protrusion amount is not limited to the above range.

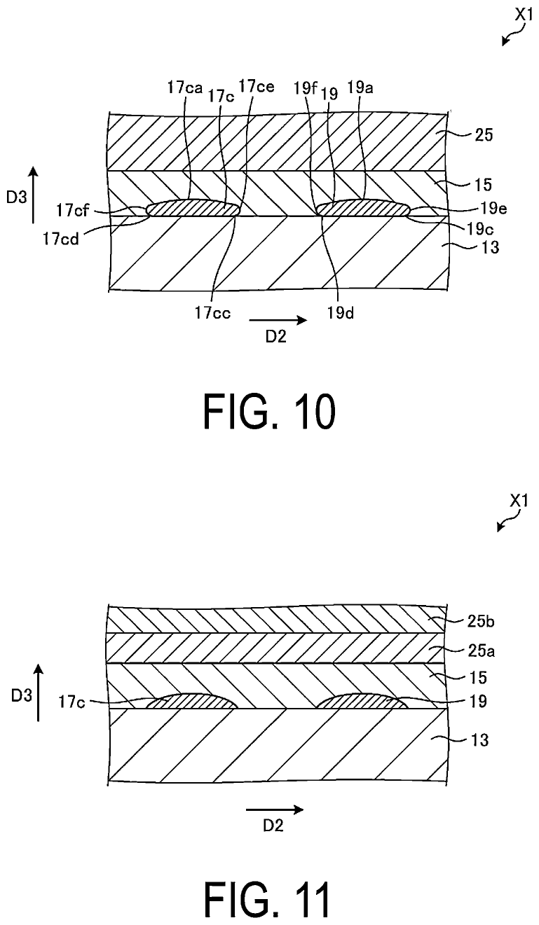

A thermal head X1 according to a fifth variation will be described with reference to FIG. 10. FIG. 10 is a cross-sectional view illustrating the main portion of the thermal head according to the fifth variation of the embodiment.

As illustrated in FIG. 10, an end portion 17ce of the third common electrode 17c in the second direction D2 protrudes out in the second direction D2 farther than an end portion 17cc of the lower surface 17cb of the third common electrode 17c in the second direction D2. The end portion 17cf of the third common electrode 17c located on the opposite side of the end portion 17ce protrudes out to the opposite side of the second direction D2 as compared with the end portion 17cd of the lower surface 17cb located on the opposite side of the end portion 17cc.

Similarly, an end portion 19e of the individual electrode 19 in the second direction D2 protrudes out in the second direction D2 farther than the end portion 19c of the lower surface 19b of the individual electrode 19 in the second direction. The end portion 19f of the individual electrode 19 located on the opposite side of the end portion 19e protrudes out to the opposite side of the second direction D2 with respect to the end portion 19d of the lower surface 19b located on the opposite side of the end portion 19c.

That is, in at least one of the third common electrode 17c and the individual electrode 19, a portion closer to the upper surfaces 17ca, 19a than the lower surfaces 17cb, 19b protrudes out toward the other of the third common electrode 17c and the individual electrode 19. In the example in FIG. 10, in the other of the third common electrode 17c and the individual electrode 19, a portion closer to the upper surfaces 17ca, 19a than the lower surfaces 17cb and 19b protrudes out toward the one of the third common electrode 17c and the individual electrode 19, but this need not be the case.

As described above, among the third common electrode 17c and the individual electrodes 19, the end portions 17ce and 19e that protrude the most in the second direction D2 may be located away from the lower surfaces 17cb and 19b in the third direction D3, respectively. In this case, the concentration point of the electric field generated between the third common electrode 17c and the individual electrode 19 by energization approaches the central portion in the thickness direction (third direction D3) of the resistor layer 15. As a result, the proportion of the portion located inside the resistor layer 15 in the electric field generated between the third common electrode 17c and the individual electrode 19 increases, so that the heat generation efficiency of the resistor layer 15 improves.

In the thermal head X1 according to the above-described embodiment and variations, the protective layer 25 located on the resistor layer 15 has been described as a single layer, but is not limited to this. FIG. 11 is a cross-sectional view illustrating the main portion of the thermal head according to the sixth variation of the embodiment.

The thermal head X1 illustrated in FIG. 11 is different from the thermal head X1 according to the embodiment in that a first protective layer 25a and a second protective layer 25b are provided instead of the protective layer 25.

The first protective layer 25a is located on the resistor layer 15. The first protective layer 25a can be made of, for example, glass. The first protective layer 25a may include, for example, lead borosilicate glass. The first protective layer 25a may further contain, for example, alumina and/or zirconia.

The first protective layer 25a has insulating properties. Thus, the first protective layer 25a is protected from corrosion due to adhesion of moisture or the like contained in the atmosphere.

The second protective layer 25b is located on the first protective layer 25a. The second protective layer 25b may be made of, for example, SiN, SiON, SiO₂, SiC, C—SiC, TiN, TiAlN, TiC, TiCN, TiSiN, CrN, DLC, or the like.

The second protective layer 25b has insulating properties. As a result, the second protective layer 25b protects from corrosion due to adhesion of moisture or the like contained in the atmosphere, or wear due to contact with a recording medium to be printed on.

A thermal printer Z1 with the thermal head X1 will be described with reference to FIG. 12. FIG. 12 is a schematic view of a thermal printer according to an embodiment.

In the present embodiment, the thermal printer Z1 includes the above-described thermal head X1, a transport mechanism 40, a platen roller 50, a power supply device 60, and a control device 70. The thermal head X1 is attached to a mounting surface 80a of a mounting member 80 disposed in a housing (not illustrated) of the thermal printer Z1. Note that the thermal head X1 is attached to the mounting member 80 such that the thermal head is aligned in the main scanning direction orthogonal to a transport direction S.

The transport mechanism 40 includes a drive unit (not illustrated) and transport rollers 43, 45, 47, and 49. The transport mechanism 40 transports a recording medium P, such as heat-sensitive paper or image-receiving paper to which ink is to be transferred, on the protective layer 25 located on a plurality of heat generating parts 9 of the thermal head X1 in the transport direction S indicated by an arrow. The drive unit has a function of driving the transport rollers 43, 45, 47, and 49. For example, a motor may be used as the drive unit. The transport rollers 43, 45, 47, and 49 may be configured by, for example, covering cylindrical shaft bodies 43a, 45a, 47a, and 49a made of a metal such as stainless steel, with elastic members 43b, 45b, 47b, and 49b made of butadiene rubber or the like. Note that, if the recording medium P is an image-receiving paper or the like to which ink is to be transferred, an ink film (not illustrated) is transported between the recording medium P and the heat generating part 9 of the thermal head X1 together with the recording medium P.

The platen roller 50 has a function of pressing the recording medium P onto the protective layer 25 located on the heat generating part 9 of the thermal head X1. The platen roller 50 is disposed extending in a direction orthogonal to the transport direction S, and both end portions thereof are supported and fixed such that the platen roller 50 is rotatable while pressing the recording medium P onto the heat generating part 9. The platen roller 50 may be formed by, for example, covering a columnar shaft body 50a made of a metal such as stainless steel with an elastic member 50b made of butadiene rubber or the like.

As described above, the power supply device 60 has a function of supplying a current for causing the heat generating part 9 of the thermal head X1 to generate heat and a current for operating the drive IC 11. The control device 70 has a function of supplying a control signal for controlling operation of the drive IC 11, to the drive IC 11 in order to selectively cause the heat generating parts 9 of the thermal head X1 to generate heat as described above.

The thermal printer Z1 causes the heat generating part 9 to selectively generate heat by the power supply device 60 and the control device 70 while transporting the recording medium P onto the heat generating part 9 by the transport mechanism 40 while pressing the recording medium P onto the heat generating part 9 of the thermal head X1 by the platen roller 50. As a result, the thermal printer Z1 performs predetermined printing on the recording medium P. Note that, if the recording medium P is image-receiving paper or the like, printing is performed onto the recording medium P by thermally transferring, to the recording medium P, an ink of the ink film (not illustrated) transported together with the recording medium P.

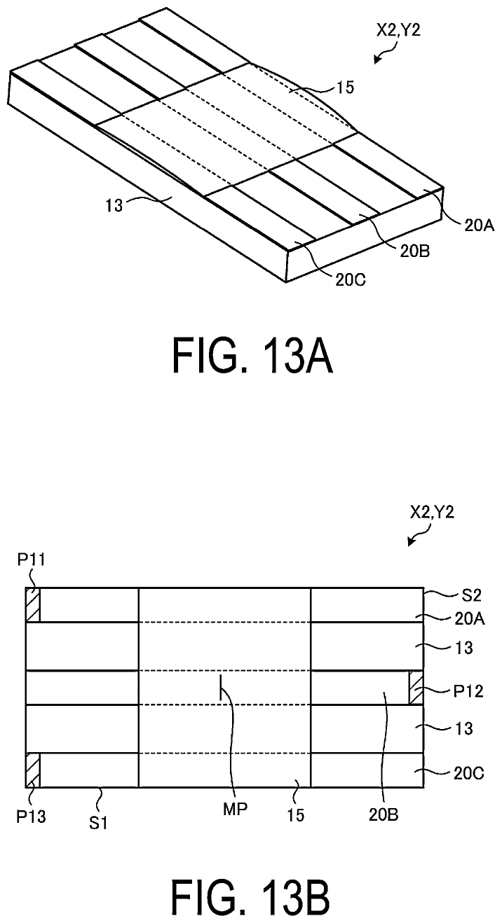

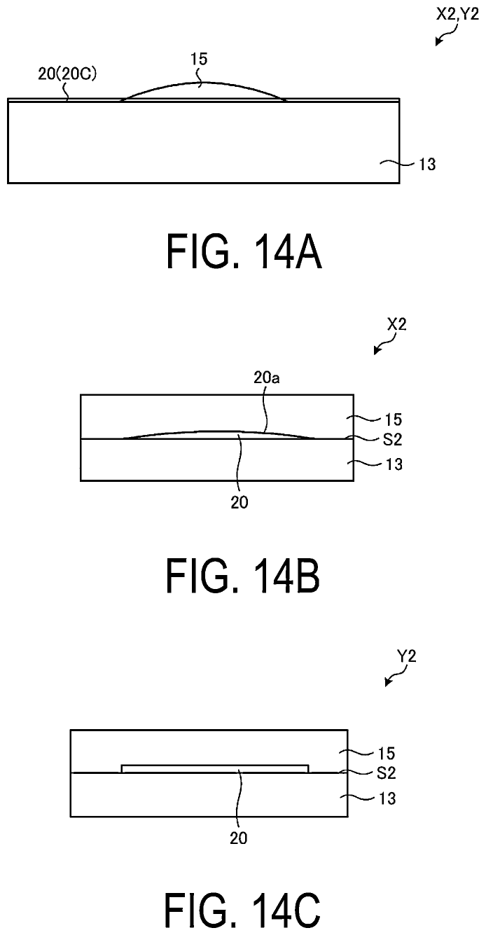

Experimental Example A simulation conducted to confirm the effect of the present invention will be described. First, the structure of the simulation model will be described with reference to FIGS. 13A to 14C.

As for the simulation model, two models of the simulation model X2 of the thermal head according to the embodiment and the simulation model Y2 of the thermal head according to the reference embodiment were created. Structures common to these two models will be described using the same figures.

FIG. 13A is a perspective view of a simulation model. FIG. 13B is a plan view of the simulation model illustrated in FIG. 13A. FIG. 14A is a side view of the simulation model illustrated in FIG. 13A as viewed from the long side. FIG. 14B is a side view of the simulation model X2 as viewed from the short side. FIG. 14C is a side view of the simulation model Y2 as viewed from the short side.

The simulation models X2 and Y2 include a heat storage layer 13, electrodes 20A to 20C located on the heat storage layer 13, and a resistor layer 15 covering a part of the heat storage layer 13 and the electrodes 20A to 20C. When the electrodes 20A to 20C are not distinguished from each other, they may be simply referred to as an electrode 20. One of the electrodes 20A and 20C and the electrode 20B corresponds to the first electrode and the other corresponds to the second electrode.

The heat storage layer 13 has a rectangular shape with a long side 51 of 300 μm, a short side S2 of 151 μm, and a height of 25 μm. The electrodes 20A to 20C extend along the long side 51 of the heat storage layer 13. The electrodes 20A to 20C are located side by side at equal intervals in the short-side S2 direction. Each of the electrodes 20A to 20C has a width of 26 μm and a thickness of 1 μm. The maximum height of the resistor layer 15 from the heat storage layer 13 is 6 μm. The resistor layer 15 covers central portions in the length direction of each of the heat storage layer 13 and the electrodes 20A to 20C. The maximum width of the resistor layer 15 is 130 μm.

In the simulation model X2, as illustrated in FIG. 14B, the upper surface 20a of the electrode 20 has a curved shape in which the center in the width direction protrudes. That is, in the simulation model X2, the central portion in the short-side S2 direction protrudes out farther than the end portion in the short-side S2 direction on the upper surface 20a of the electrodes 20. On the other hand, as illustrated in FIG. 14C, the simulation model Y2 is different from the simulation model X2 in that a transverse section of the electrode 20 has a rectangular shape.

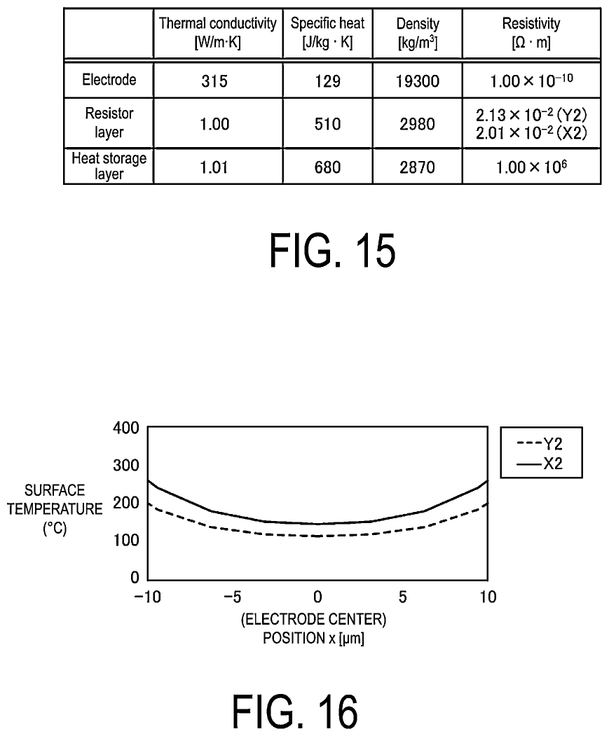

FIG. 15 is a table summarizing physical property values used in the simulation. FIG. shows values of the thermal conductivity, specific heat, density, and resistivity of the electrode 20, the resistor layer 15, and the heat storage layer 13. Note that the value of the resistivity of the resistor is slightly different between the simulation models Y2 and X2. This is because the resistance value between the first electrode and the second electrode (to be precise, the resistance value between the sites P11 and P13 and the site P12 in FIG. 13B) was adjusted to be equal between the simulation models Y2 and X2.

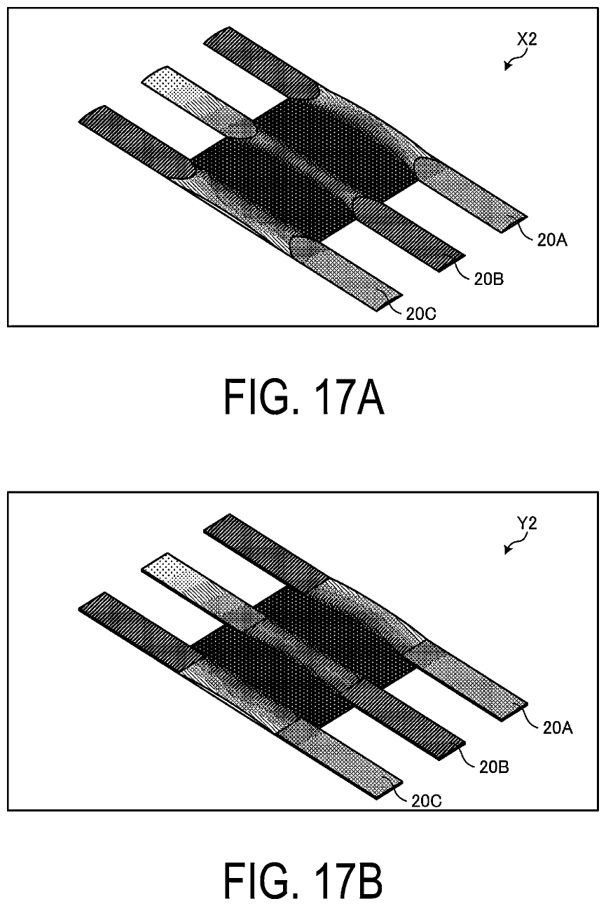

In the simulation models X2 and Y2 as described above, the heat generation amount and the temperature of each site were simulated by applying one pulse (100 μs) of voltage so that the sites P11 and P13 were 20V and the site P12 was 0V in FIG. 13B. The results are shown in FIGS. 16, 17A, and 17B.

FIGS. 17A and 17B are diagrams illustrating the heat generation amount of each portion. In FIGS. 17A and 17B, a portion having a large heat generation amount is illustrated in a dark color. According to FIGS. 17A and 17B, it can be seen that in the simulation model X2, a portion having a large heat generation amount is spread toward the center in the width direction of the electrodes 20A to 20C as compared with the simulation model Y2. In this simulation, the portion on the outer side farther than the electrode 20A and the electrode 20C is not taken into consideration, and thus the vicinity of the electrode 20B located at the center is in a state closest to the real thing.

FIG. 16 is a graph showing the temperature on the upper surface of the resistor layer 15, and shows the temperature of a portion indicated by MP in FIG. 13B. As can be seen from FIG. 16, in the simulation model X2, the temperature of the portion located on the electrode 20B on the upper surface of the resistor layer 15 is higher than that in the simulation model Y2.

From the above simulation, it was confirmed that the present invention is effective in improving the print image quality of the thermal head.

Although the embodiments of the present disclosure have been described above, the present disclosure is not limited to the embodiments described above, and various modifications can be made without departing from the spirit thereof. For example, two or more third common electrodes 17c and individual electrodes 19 according to the embodiment and each variation may be appropriately combined. Only one of the third common electrode 17c and the individual electrode 19 need be the third common electrode 17c or the individual electrode 19 according to the embodiment and each variation.

As the thermal head X1, for example, a planar head in which the heat generating part 9, the heat storage layer 13, the common electrode 17, the individual electrode 19, and the like are located on the main surface 7e of the substrate 7 has been exemplified. The configuration is not limited thereto, and the heat generating part 9, the heat storage layer 13, the common electrode 17, the individual electrode 19, and the like may be located on a surface other than the main surface 7e of the substrate 7.

A so-called thick film head in which the resistor layer 15 is formed by printing has been described, but the configuration is not limited to the thick film head. The resistor layer may be used for a so-called thin film head formed by sputtering.

The connector 31 may be electrically connected to the head base 3 directly without providing the FPC 5. In this case, a connector pin (not illustrated) of the connector 31 may be electrically connected to the electrode pad 10.

Although the thermal head X1 including the covering layer 27 is exemplified, the covering layer 27 may not be necessarily provided. In that case, the protective layer 25 (or the first protective layer 25a and the second protective layer 25b) may be extended to the region where the covering layer 27 was provided.

Further effects and variations can be readily derived by those skilled in the art. Thus, a wide variety of aspects of the present disclosure are not limited to the specific details and representative embodiments represented and described above. Accordingly, various changes are possible without departing from the spirit or scope of the general inventive concepts defined by the appended claims and their equivalents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A thermal head comprising:
a substrate;
electrodes located on the substrate and extending along a first direction of the substrate; and
a resistor layer located on the substrate and on the electrode; wherein
the electrodes comprise a first electrode and a second electrode arranged at a predetermined interval in a second direction intersecting the first direction;
at least one of the first electrode and the second electrode has a central portion protruding out farther in the second direction than an end portion in the second direction on an upper surface located below the resistor layer;
in the at least one of the first electrode and the second electrode, the end portion on the upper surface protrudes out farther in the second direction toward another of the first electrode and the second electrode farther than an end portion in the second direction on a lower surface of the at least one of the first electrode and the second electrode.

2. (canceled)

3. (canceled)

4. The thermal head according to claim 1, wherein
in the at least one of the first electrode and the second electrode, a thickness of the resistor layer located on a central portion along the second direction is smaller than a thickness of the resistor layer located on an end portion along the second direction.

5. The thermal head according to claim 1, wherein
an unevenness of an interface between the upper surface of the at least one of the first electrode and the second electrode and the resistor layer is larger than an unevenness of an interface between the resistor layer and the substrate.

6. The thermal head according to claim 1, further comprising:
a protective layer located on the resistor layer; wherein
a thickness of the protective layer located on the first electrode and the second electrode is smaller than a thickness of the protective layer positioned on the resistor layer located between the first electrode and the second electrode.

7. The thermal head according to claim 1, wherein
the substrate has a heat storage layer on at least a part of an upper surface; and
the electrodes and the resistor layer are located on the heat storage layer.

8. A thermal printer, comprising:
the thermal head described in claim 1;
a transport mechanism configured to transport a recording medium onto a heat generating part located on the substrate; and
a platen roller configured to press the recording medium onto the heat generating part.
